(19) United States
(12) Patent Application Publication
(10) Pub. No.: US 2025/0375342 A1
(43) Pub. Date: Dec. 11, 2025

(54) ROBOT MASSAGER

(71) Applicant: Robotic Therapeutics FZ-LLC, Dubai (AE)

(72) Inventors: Denis Ledenkov, Dubai (AE); Vitalii Kurdiuk, Dubai (AE); Maxim Gladilov, Dubai (AE); Alexander Naumov, Dubai (AE)

(21) Appl. No.: 19/192,575

(22) Filed: Apr. 29, 2025

Related U.S. Application Data
(60) Provisional application No. 63/657,069, filed on Jun. 6, 2024.

(51) Int. Cl. A61H 15/00

(52) U.S. Cl. CPC A61H 15/0078; A61H 2015/005; A61H 2015/0071; A61H 2201/0142; A61H 2201/0176; A61H 2201/1215; A61H 2201/1607; A61H 2201/1659; A61H 2201/1664; A61H 2201/5025; A61H 2201/5043; A61H 2201/5048; A61H 2201/5092; A61H 2201/5097; A61H 2209/00

(57) ABSTRACT

Robot for massaging patients includes housing, massage bed, massaging tool positioning system, massaging tool, and control system; positioning system includes linear movement module, load-bearing bracket, and robotic arm; control system includes a computer vision system, a computer, a robotic arm control unit, and a human interface; massage bed is positioned above housing, linear movement module is mounted on housing and aligned along massage bed, and is at least half as long as massage bed; load-bearing bracket is mounted on linear movement module; robotic arm is mounted on load-bearing bracket above massage bed; and massaging tool is mounted on robotic arm; computer vision system includes an stationary bracket and two machine vision cameras, maximum distance between cameras being at least half as long as massage bed; cameras are mounted on stationary bracket and positioned above massage bed; computer and robotic arm control unit are located inside housing.

### FIELD OF THE INVENTION

The present invention relates to robotic manipulators for massage physiotherapy. The present invention is used to automate massage procedures, particularly in the medicine, physical therapy, and cosmetology in order to provide a comprehensive massaging effect on certain muscle groups, skin, and subcutaneous adipose tissues.

### DESCRIPTION OF THE RELATED ART

There is a conventional automatic physiotherapeutic system for treatment and prevention (see EP 3760178 A1 and WO 2020/148624 [1], discussed below). This automatic system relates to rehabilitation means and is utilized in aesthetic medicine and sports medicine, particularly, to treat various ailments, such as cellulite, lymphatic and venous congestion, headaches, back pain, lower back pain, neck pain, etc., by means of roller vibrocompression (compressive microvibration) by spheres.

The system in [1] utilizes the method of roller vibrocompression by spheres that is adapted to disorders to which all patients are more or less susceptible; the method affects the vascular system, enhancing microcirculation, the lymphatic system, and tissues, for muscle relaxation or toning, depending on the indications.

The system in [1] for physiotherapeutic treatment of a human body includes a control unit and a manual massaging tool used to perform massaging manipulations, wherein the control unit is equipped with software that determines the optimum protocol for each particular case, and the impact tool comprising of a roller with spheres arranged on the bearing axes. The roller is driven by an electric motor to deliver the impact from the vibrocompression to patient's body and produce massaging effect.

However, the conventional system in [1] contains certain drawbacks.

This system requires the attendance of a qualified specialist who will use the manual massaging tool to perform a massage by pressing the tool against the patient's body. Because the specialist needs to be highly trained, it makes the massage procedures more expensive.

In addition, massage procedures are dependent on a human factor, which reduces stability and repeatability thereof, thus impairing their quality.

Another conventional system is a system based on a humanoid robotic arm (see Appl. Sci. 2019, 9(20), 4294; doi.org/10.3390/app9204294 [2]) capable of imitating the motions of a Chinese massage specialist.

The conventional system in [2] includes a massaging attachment in the form of a three-fingered hand for kneading and a miniature robotic massaging attachment for such movements as tapping, kneading, vibration, and rolling. In addition, it includes a binocular technical vision module.

The conventional system in [2] is designed to fulfil the clinical requirements for relieving lower back pain and leg pain in elderly patients during Chinese massage therapy.

The main drawback of this system is its limited workspace, in which the robotic arm is able to perform massaging movements automatically. The workspace is a curved strip in the shape of three quarters of a cylinder, with a radius of about 0.5 m and a width of about 0.2 m.

Another drawback of the system in [2] is the special design of its robotic arm, which adds to the cost of the system.

Yet another drawback of the system [2] is that it utilizes a single cantilevered binocular technical vision module, which does not provide a sufficient view of the patient to identify their body position and location.

Closest in the prior art to the proposed invention is a massage robot (see U.S. Pat. No 10,434,658B2, published in 2019 [3]).

This conventional massage robot in [3] includes one or more robotic arms, a computer vision system, and a control system. The computer vision system captures the images of the patient. The control system includes an image processing module and a movement controller. The image processing module processes images to identify the spot on the patient's body to be massaged. The movement controller controls the robotic arm to perform massage at the identified massage spot.

The massage robot in [3] may also comprise an ultrasonic sensor for capturing ultrasonic images, a pressure sensor for measuring the pressure exerted by the robotic arm on the treated spot, a treated surface stiffness sensor, and a temperature sensor for measuring the temperature of the treated surface. The data provided by these sensors can be processed by the control system and used by the movement controller to control the robotic arm.

The main drawback of the conventional massage robot in [3] is that it uses only one device to move the massaging attachment, in particular the robotic arm, whose workspace is a sphere-like area, while the patient's body areas to be massaged are located along a single axis, since the patient's height is usually much greater than their width. This fact adds to the cost of the massage robot, in case a robotic arm with a large workspace is used. If a robotic arm with a smaller workspace is used, the massage robot loses its ability to perform an automatic massage of a substantial number of massage areas without requiring the patient to change their relative position.

Another drawback of the massage robot in [3] is that it lacks two or more machine vision cameras capable of fully viewing the patient on the massage bed, which does not allow to reliably identify the patient's body position and location.

Yet another drawback of the massage robot in [3] is that it is incapable of performing roller vibrocompression by spheres, which is effective against such ailments as cellulite, lymphatic and venous congestion, back pain, lower back pain, neck pain, etc., and that it is also does not allow to track the body position at a sufficiently high speed to create the feeling of a seamless massage.

### SUMMARY OF THE INVENTION

The problem to be solved by the proposed invention is to create an effective robot for massaging patients, which would provide safe, accurate, and effective massaging physiotherapy of the patient's body.

The objective of the proposed invention is to improve the massage safety, to enhance the quality of the massage through more accurate positioning of the massaging tool on the patient's body, and to increase the massage effectiveness.

To achieve these objectives, the platform for performing an autonomous physiotherapeutically massage on individuals includes a main unit (housing), a massage bed, a massaging tool positioning system, a massaging tool and a control system. The massaging tool positioning system includes a linear movement module, a load-bearing bracket, and a robotic arm. The control system includes a computer vision system, a computer, a robotic arm control unit, and a human interface. The massage bed rests on top on the main unit, the linear positioning module is attached to the side of the main unit and is aligned with the massage bed, its moving range is half the length of the massage bed. The load-bearing bracket is mounted on the linear movement module; the robotic arm is mounted on the load-bearing bracket above the massage bed; and the massaging tool is mounted on the robotic arm. The computer vision system includes an stationary bracket and at least two machine vision cameras, wherein the maximum distance between the cameras is at least half as long as the massage bed itself, and the cameras are mounted on the stationary bracket. The cameras are positioned above the massage bed so that the patient on the massage bed is fully visible. The computer and the robotic arm control unit are housed in the main unit under the massage bed. The human interface includes an emergency stop button, a manual control panel, a patient interface monitor, and a patient informing audio system.

Preferably, the control system of the massage robot further contains an additional machine vision camera mounted on a movable carriage.

Preferably, the massaging attachment of the massage robot is designed for roller vibrocompression by spheres.

Preferably, the human interface includes a control panel modelled on the basis of a tablet computer and wirelessly connected to a computer.

The computer vision system may comprise four machine vision cameras positioned on a single axis along the massage bed.

The computer vision system may comprise four machine vision cameras positioned at the vertices of a rectangle parallel to the massage bed.

Additional features and advantages of the claimed solution are described in the following disclosure and proved by the actual practice of the invention. These advantages and improvements can be achieved by intelligent agents constructed and trained following the claimed method, precisely following the disclosure, along with the accompanying claims and drawings.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a general view of the massage robot.

FIG. 2 shows a general (rear) view of the massage robot.

FIG. 3 shows a cross-sectional view of the massage robot.

FIG. 4 shows a general view of the massage robot with a patient.

FIG. 5 shows the manual control panel.

FIG. 6 shows the massage robot with an additional machine vision camera.

FIG. 7 illustrates a tablet computer-based control panel.

FIG. 8 illustrates the positioning of four machine vision cameras on a single axis along the massage Bed.

FIG. 9 illustrates the positioning of four machine vision cameras at the vertices of a rectangle parallel to the massage bed.

### DETAILED DESCRIPTION OF EMBODIMENTS OF THE INVENTION

Reference will now be made in detail to the preferred embodiments of the present invention, examples of which are illustrated in the accompanying drawings.

The proposed invention is illustrated by specific examples of its embodiment, which are by no means limiting and only serve as illustrations of how the objective of the invention can be achieved using the disclosed set of essential features, and how the existing problem can be solved.

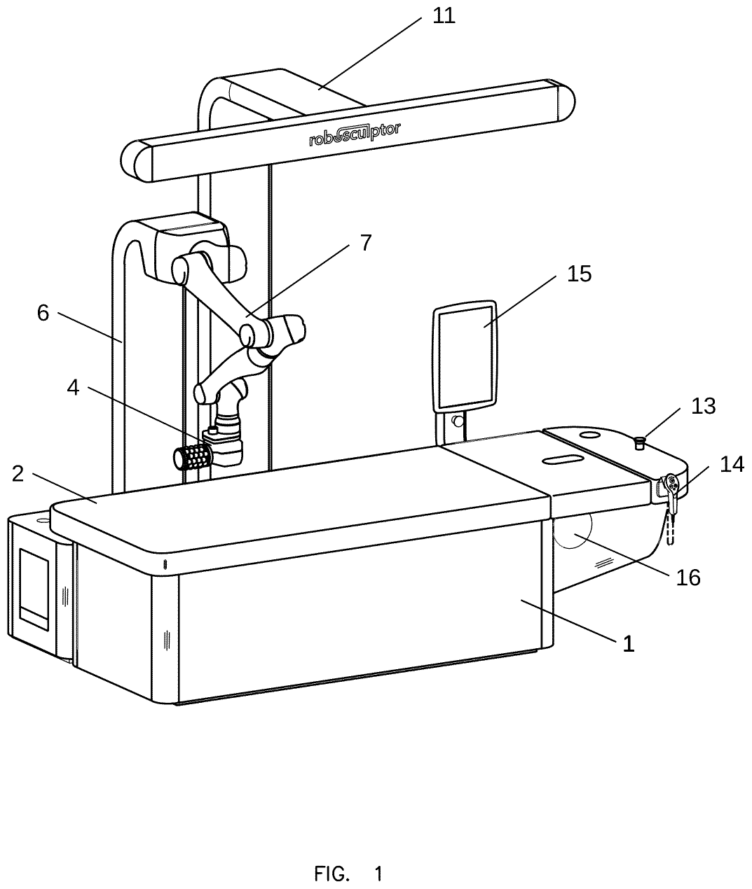

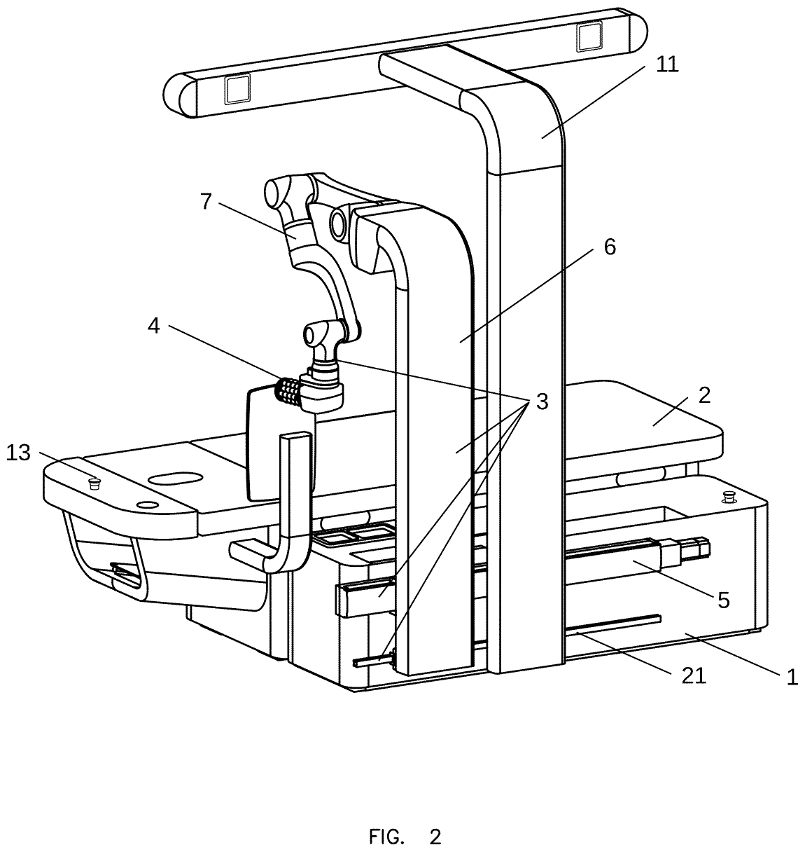

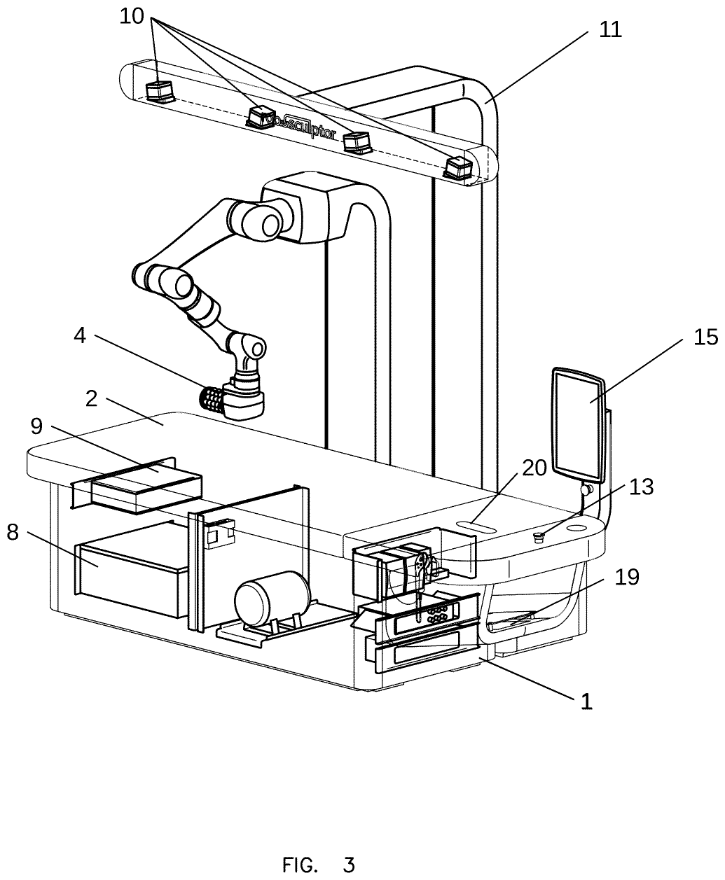

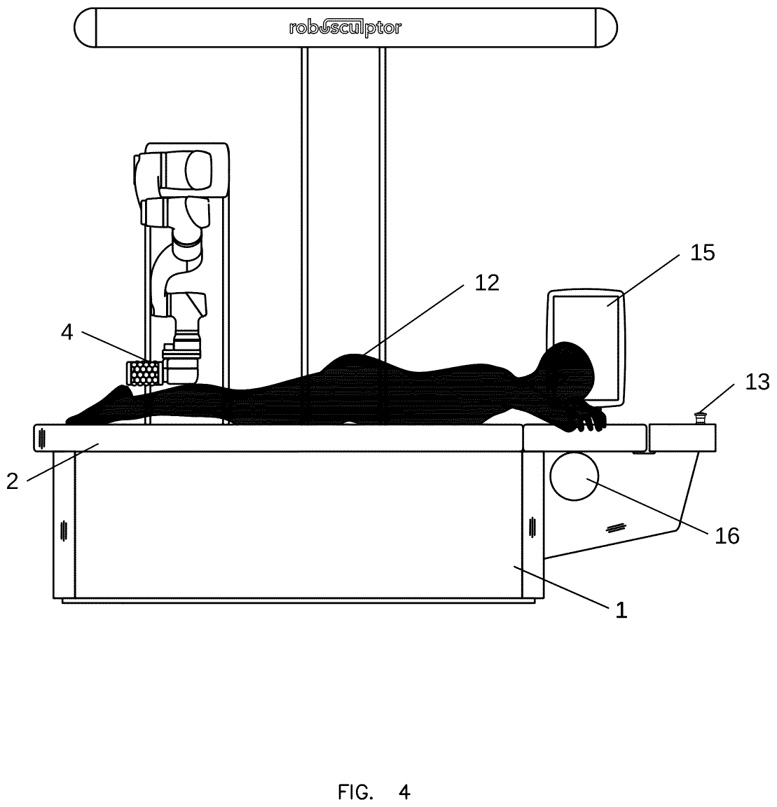

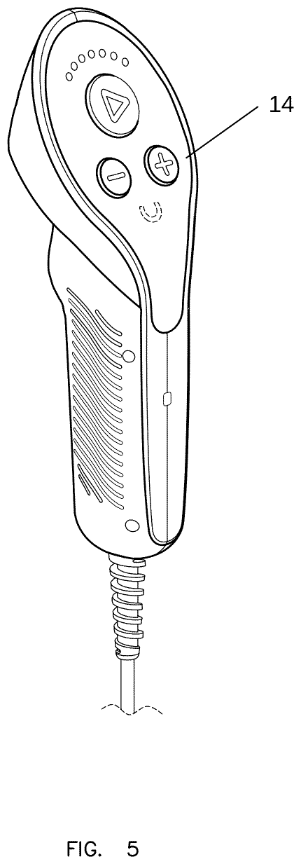

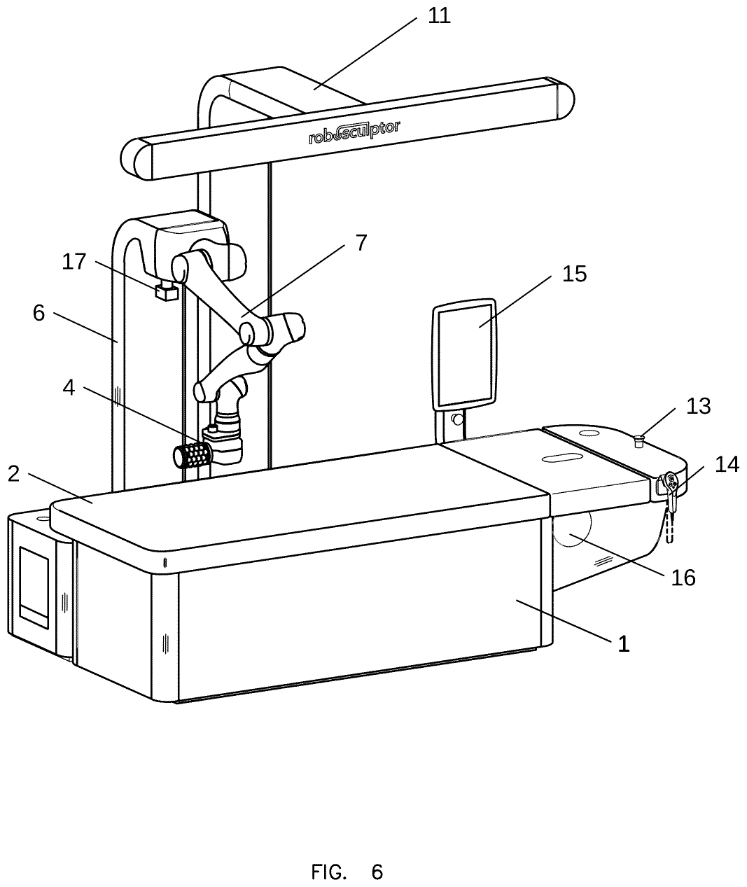

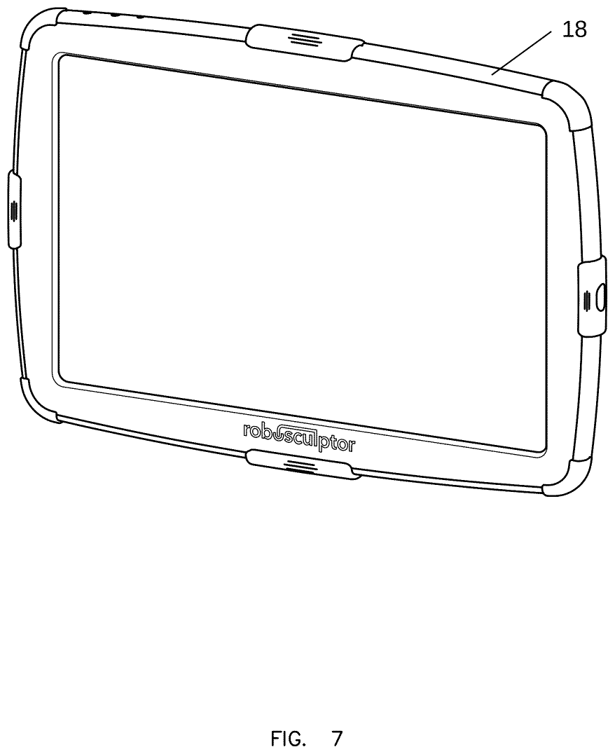

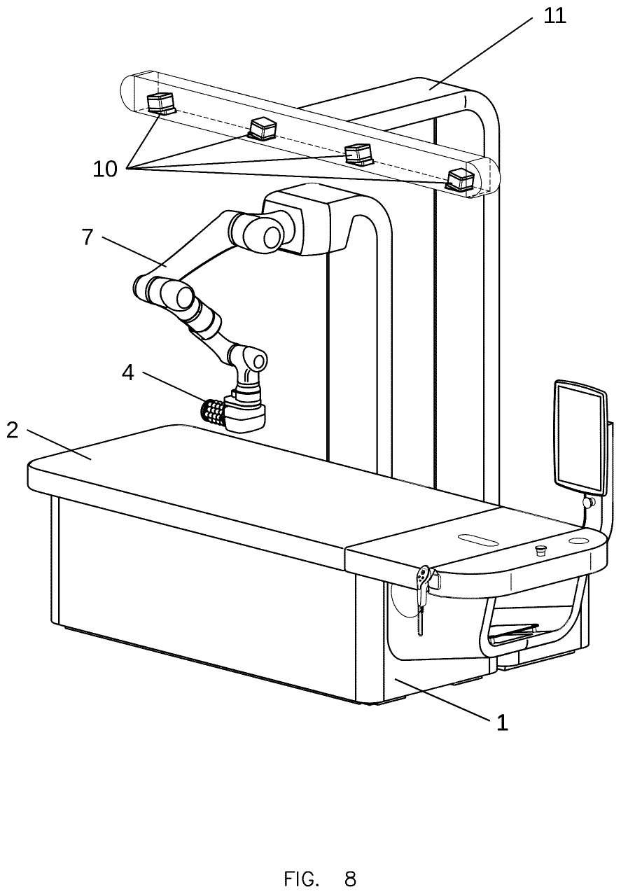

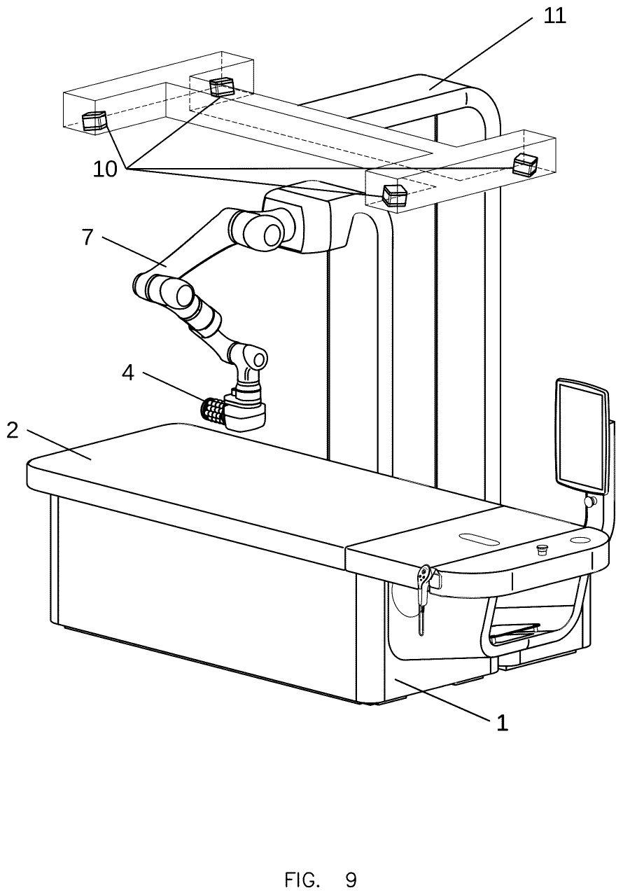

FIGS. 1-9 show the following constituent parts and elements of the proposed robot for massaging the patient:
1—main unit;
2—massage bed;
3—massaging tool positioning system;
4—massaging tool;
5—linear movement module;
6—load-bearing bracket;
7—robotic arm;
8—computer;
9—robotic arm control unit;
10—machine vision camera;
11—stationary bracket;
12—patient;
13—emergency stop button;
14—manual control panel;
15—patient interface monitor;
16—patient informing audio system;
17—additional machine vision camera;
18—tablet computer-based control panel;
19—additional patient interface monitor;
20—face cradle;
21—additional linear guide.

The robot for massaging patients includes a main unit (body) (1), a massage bed (2), a massaging tool positioning system (3), a massaging tool (4), and a control system.

The massaging tool positioning system (3) includes a linear movement module (5) mounted on the main unit (1) to the side of the massage bed (2), the module (5) bearing a load-bearing bracket (6) and a robotic arm (7) mounted on the load-bearing bracket (6) above the massage bed (2).

The main unit (1) provides a rigid and reliable attachment of equipment to it, in particular the linear movement module (5) and the massage bed (2), thereby ensuring accurate positioning of the robotic arm (7) attached to the linear movement module (5) by means of the load-bearing bracket (6), relative to the massage bed (2), which improves the accuracy of the positioning of the massaging tool (4) and, in turn, makes the massage procedure safer.

The linear movement module (5) is mounted on the main unit (1) and aligned along the massage bed (2), and is at least 30% as long, and preferably half as long as the massage bed (2) itself. The linear movement module (5) is controlled by the control system that is capable of moving the load-bearing bracket (6) with the robotic arm (7) to a predetermined position relative to the massage bed (2).

The robotic arm (7) is equipped with a massaging tool (4).

The control system includes a computer vision system, a computer (8), a robotic arm (7) control unit (9), and a human interface.

The computer vision system at least two machine vision cameras (10), wherein the extreme cameras (10) are spaced at a distance at least half as long as the massage bed (2) itself and mounted on the stationary bracket (11) above the massage bed (2) enabling to see the patient (12) on the table entirely.

The computer (8) controls the massage robot and the whole of its constituent parts and is housed in the main unit (1).

The robotic arm control unit (9) follows the instructions by the computer (8), controlling the robotic arm (7), and which is housed in the main unit (1). The human interface includes an emergency stop button (13), a manual control panel (14), a patient interface monitor (15), and a patient informing audio system (16). By means of the emergency stop button (13), the patient (12) is able to stop the massage at any time, which makes the massage safer.

The manual control panel (14) is a compact device equipped with buttons and switches for starting and stopping massage, as well as for setting the massage parameters; the panel (14) has a wired connection the computer (8) and the patient has access to this panel (14) during the massage procedure. The patient's (12) ability control the massage process allows to improve its quality and safety.

The patient interface monitor (15) is a display that displays visual information about the massage being performed, as well as any other additional information. The monitor (15) can be mounted on the main unit (1), to the side of the massage bed (2).

The patient informing audio system (16) is an audio system that plays back audio information about the massage being performed, as well as any other sounds, particularly music. The audio system (16) can be mounted on the main unit (1) near the headboard. Using the patient interface monitor (15) and the patient informing audio system (16), it is possible to inform the patient (12) in order to position them in the most convenient way for the massage, thereby improving the quality of the massage and the comfort of the patient (12) during the massage.

The massage robot may comprise an additional machine vision camera (17) mounted on the load-bearing bracket (6).

The human interface may comprise the tablet computer-based control panel (18), equipped with a touch screen, and wirelessly connected to the computer (8).

For the patient's convenience, an additional patient information monitor (19) can be placed under the massage bed (2) opposite the face cradle (20). The face cradle (20) is designed for the patient's (12) face when lying on their stomach, thereby allowing them to lie on the massage bed in a comfortable position without obstructing their breathing.

For a stronger connection between the load-bearing bracket (6) and the main unit (1), the positioning system may comprise an additional linear guide (21) aligned in parallel to the linear movement module (5) axis. Moreover, the additional linear guide (21) provides extra mechanical connection between the main unit (1) and the load-bearing bracket (6), reducing mechanical load on the linear movement module (5), which increases the positioning accuracy of the massaging tool (4).

The massaging tool (4) may be a massaging attachment of the conventional solution [1] used for roller vibrocompression by spheres, comprising an electric motor, to which a rotor with multiple axes is attached, the axes bearing rotating elements that produce the massaging effect of roller vibrocompression by spheres when coming into contact with the patient's body.

The computer vision system may comprise four machine vision cameras (10) mounted on the stationary bracket (11) above the massage bed (2) and positioned on a single axis along the massage bed (2).

In an exemplary embodiment of the massage robot, the computer vision system may comprise four machine vision cameras (10) mounted on the stationary bracket (11) and positioned at the vertices of a rectangle parallel to the massage bed (2).

For instance, the massage robot can massage the patient as follows.

A massage session is started by pressing a button on the manual control panel (14). The patient (12) lies on the massage bed (2) in a predetermined position, for example, on their back. The patient's (12) desired position is displayed on the patient interface monitor (15), while the patient informing audio system (16) provides voice explanations. Then, the patient (12) confirms that they are ready for the massage by pressing a button on the manual control panel (14).

Then, the control system obtains and processes the image of the patient (12). The images can be obtained by means of machine vision cameras (10), as well as, according to an exemplary embodiment, by means of the additional camera (17). machine vision cameras are one of the most convenient ways of obtaining information as they measure the body surface coordinates, which enables the computer (8) to calculate the movement trajectories of the massaging tool (4), controlled by the massaging tool positioning system (3), on the body of the patient (12) most simply and accurately. When at least two machine vision cameras (10), spaced at a distance at least half as long as the massage bed (2) itself and mounted on the stationary bracket (11) above the massage bed (2), are used, it allows to obtain a high-quality image of the entire patient's body at the desired angle, without the need to move the cameras (10) away from the patient (12) or to increase the field of view of the cameras (10), which allows to improve the calculation of massage trajectories. By mounting the additional camera (17) on the load-bearing bracket (6) also carrying the robotic arm (7), it is possible to control the massaging tool (4) attached to the robotic arm (7) easily and reliably, since the camera (17) has a fixed position in the coordinate system of the robotic arm (7).

The control system manipulates the robotic arm (7) to perform the massage using methods known from prior art [2] and [3]. For example, the control system identifies the patient's body position and locates areas to be massaged, based on the processed images of the patient. Then, the computer (8) of the control system controls the linear movement module (5), which moves the load-bearing bracket (6) and sends instructions to the robotic arm control unit (9), which moves the robotic arm (7) with the massaging tool (4) attached into the position that is most suitable for the massage, for example, one closest to the area of the patient's body (12) that is to be massaged.

Please note that for a typical 2 m long and 0.8 m wide massage bed, the above configuration with the robotic arm (7) mounted on a longitudinally positioned linear movement module (5) and above the massage bed (2), a robotic arm (7) with a smaller radius of the massaging tool (4) movement area, e.g., 0.5 m, can be used, which, given the carriage movement range of 1 m (half the length of the massage bed (2)) covers the entire length of a 2 m long massage bed, thus ensuring that the entire patient's body can be massaged. Please also note that the robotic arm (7) with limited movement area has a lower mass and power-to-weight ratio, which makes it safer to use, and also has a lower cost, which makes the massage robot more economical.

Then, the control system obtains and processes additional images of the patient, if necessary, and refines the location of the body area to be massaged. By mounting the machine vision camera (17) on the load-bearing bracket (6) together with the robotic arm (7), it is possible to fix their mutual positioning, which increases the control accuracy of the robotic arm (7) and therefore improves safety of the massage robot operation. Then, the control system manipulates the robotic arm (7) to move the massaging tool (4) to the affected area in order to perform the massage in a given way.

The massage can be performed in the following way. The massaging tool (4) is pressed against the predetermined area to be massaged using the method from references [2] and [3]. The rotor of the massaging tool (4) is actuated by the electric motor in the attachment. As a result, the rotating spherical massaging elements located on the multiple rotor axes touch the body surface in the area to be massaged, thus producing the effect of roller vibrocompression by spheres, as known from reference [1], which affects the skin and subcutaneous tissues in order to restore blood circulation, and to make connective tissues more resistant and elastic.

During the massage, the patient can control the process using the manual control panel (14) or stop the massage immediately using the emergency stop button (13).

The massage session (including preparation, massage, and stopping) can also be controlled by a qualified specialist using a tablet and/or computer-based control panel (18).

An embodiment of the massage robot, in which the computer vision system includes four machine vision cameras (10) positioned on a single axis along the massage bed (2), has the following advantages. Firstly, the cameras (10) provide a full view of the patient's body (12) from above, thereby ensuring accurate mapping of the upward-facing surface of the patient's body (12). The more accurately the surface is mapped, the more effectively it can be massaged. Secondly, when four cameras (10) are used, then the image of the whole patient's body (12) can be obtained from the desired angle and at a smaller distance from the massage bed (2), thus reducing the required size of the stationary bracket (11) and the overall dimensions of the massage robot.

An embodiment of the massage robot, in which the computer vision system includes four machine vision cameras (10) positioned at the vertices of a rectangle parallel to the massage bed (2), has the following advantages. The cameras (10) provide a full view of the patient's body (12) from above and from the sides, thereby ensuring accurate mapping of both the upward-facing and the lateral surfaces of the patient's body (12). This allows to provide a better massage of both the upward-facing and the lateral surfaces of the patient's body (12).

The main unit (1) may be a stand with a load-bearing frame, an equipment mounting system, and side panels.

The control system may be a system similar to the conventional system [3] that includes an image processing module and a movement controller. The image processing module processes images to identify the spot on the patient's body to be massaged. The movement controller controls the robotic arm to perform massage at the identified massage spot.

The control system may contain machine vision cameras (10, 17), such as commercially available blaze-101 cameras produced by Basler (see baslerweb.com/en-en/shop/blaze-101/, accessed on Oct. 19, 2023).

The massage bed (2) may be a commercially available massage bed, such as medicalexpo.com/prod/tecnomed-italia/product-4579163-1103617.html, accessed on Oct. 19, 2023, or a similar one, which can be mounted on the main unit (1).

The main unit (1), the load-bearing bracket (6), and the stationary bracket (11) may be made from welded steel structures or from commercially available construction aluminium profiles.

The linear movement module (5) may be a commercially available robotic arm linear movement module, such as (see rollon.com/usa/en/family/actuator-system-line/robot-transfer-unit/, accessed on Aug. 4, 2023).

The robotic arm (7) may be any of such models as LBR Med 7 R800 or LBR Med 14 R820 produced by KUKA Aktiengesellschaft, Zugspitzstraße 140, 86165 Augsburg, Germany (sec kuka**com/en-de/industries/health-care/kuka-medical-robotics/lbr-med, accessed on Oct. 19, 2023). These robotic arms are currently commercially available and have six degrees of freedom, which allows them to move the massaging attachment to any given point within the predetermined area and orient the attachment at any angle.

The massaging tool (4) may be an attachment comprising an electric motor, to which a rotor with multiple axes is attached, the axes bearing rotating spherical massaging elements, which is similar to conventional massaging attachments for roller vibrocompression by spheres, such as (see beautylizer.com/, accessed on Oct. 19, 2023; pubmed.ncbi.nlm.nih.gov/35199449/, accessed on Oct. 19, 2023).

The references [1]-[4] are incorporated herein by reference in their entirety.

It should also be appreciated that various modifications, adaptations, and alternative embodiments thereof may be made within the scope and spirit of the present invention. The invention is further defined by the following claims.

What is claimed is:

1. A robot for massaging patients, comprising:
a massage bed;
a massaging tool;
a massaging tool positioning system; and
a control system for controlling position of the massaging tool using the massaging tool positioning system,
wherein the massaging tool positioning system includes (i) a linear movement module, a (ii) load-bearing bracket mounted on the linear movement module, and (iii) a robotic arm mounted on the load bearing bracket above the massage bed;
wherein the linear movement module is aligned to move longitudinally along the massage bed;
wherein the massaging tool is mounted on the robotic arm;
wherein the control system comprises (a) two cameras above the bed, with a distance between the cameras being at least half of a length of the massage bed, (b) a processor controlling the cameras, and (c) a human interface for input of commands to the control system; and
wherein the human interface comprises a manual control panel and a patient interface display.

2. The robot of claim 1, wherein the two cameras are mounted on a stationary bracket.

3. The robot of claim 1, wherein the massaging tool uses roller vibrocompression by spheres.

4. The robot of claim 1, wherein the human interface comprises a tablet computer-based control panel that interfaces wirelessly to the processor.

5. The robot of claim 1, wherein the human interface comprises a patient audio interface.

6. The robot of claim 1, wherein the human interface comprises an emergency stop button.

7. The robot of claim 1, further comprising a third camera mounted on the load-bearing bracket.

8. The robot of claim 1, further comprising a third camera and a fourth cameras, wherein the first, second, third and fourth cameras are all positioned on a single axis along the massage bed.

9. The robot of claim 1, further comprising a third camera and a fourth cameras, wherein the first, second, third and fourth cameras are all positioned to form a rectangle parallel to the massage bed and above the massage bed.

10. The robot of claim 1, wherein the two cameras are mounted on the stationary bracket.

11. The robot of claim 1, further comprising a housing, wherein the massage bed is above the housing and wherein the linear movement module is mounted on the housing.

12. The robot of claim 1, further comprising a robotic arm control unit for control of the robotic arm, wherein the processor and the robotic arm control unit are located inside the housing.

13. The robot of claim 1, wherein the linear movement module is at least 30% as long as the massage bed.
